(19) United States
(12) Patent Application Publication
(10) Pub. No.: US 2010/0080734 A1
(43) Pub. Date: Apr. 1, 2010

(54) TIP PLATE FOR HIGH THROUGHPUT SCREENING APPLICATIONS

(75) Inventors: John M. Brophy, Taylorsville, UT (US); West L. Price, Draper, UT (US)

Correspondence Address: TRASKBRITT, P.C., P.O. BOX 2550, SALT LAKE CITY, UT, 84110, US

(73) Assignee: SORENSON BIOSCIENCE, INC., Salt Lake City, UT (US)

(21) Appl. No.: 12/577,642

(22) Filed: Oct. 12, 2009

Related U.S. Application Data
(63) Continuation-in-part of application No. 10/737,733, filed on Dec. 16, 2003.
(60) Provisional application No. 60/433,909, filed on Dec. 16, 2002.

(51) Int. Cl. B01L 3/02

(52) U.S. Cl. 422/100

(57) ABSTRACT

A pipette tip plate includes individual tips organized in ranks and files to match in pattern the array of wells in a standard well plate and held together by a web structure which permits individual tips to move into registration with individual pins of a robotic head.

### CROSS-REFERENCE TO RELATED APPLICATION

This application is a continuation-in-part of co-pending U.S. patent application Ser. No. 10/737,733, filed Dec. 16, 2003, entitled TIP PLATE FOR HIGH THROUGHPUT SCREENING APPLICATIONS, and claims the priority of U.S. Provisional Patent Application Ser. No. 60/433,909, filed Dec. 16, 2002, for TIP PLATE FOR HIGH THROUGHPUT SCREENING. Each of the foregoing applications is incorporated herein by reference in their entirety.

### BACKGROUND OF THE INVENTION

This invention pertains to robotic manipulations of pipette tips to register with the individual wells of well assay plates, often referred to as “microplates,” because the individual wells of such plates are sized to contain no more than microliter quantities. Such plates comprise individual wells (analogous to miniature test tubes) organized in ranks and files in standardized patterns. An assay plate typically has 96, 384 or even 1536 sample wells arranged in a 2:3 rectangular matrix. Some more recent microplates have been manufactured with 3456 or 9600 wells, always retaining the 2:3 rectangular matrix. One specific application for well plates of this type is for use in connection with the high throughput screening (HTS) techniques routinely followed for identifying promising constituents for new drugs. Another application is in connection with polymerase chain reaction (PCR) procedures. As rapid throughput capabilities have evolved, the standardized well plate arrays have also evolved, progressing from a row (or single rank) of 8 wells, to an array of 96 wells (organized as 8 files of 12 ranks), followed by an array of 384 wells (16 files of 24 ranks). This trend has continued. An array of 1536 wells (organized as 32 files of 48 ranks) is currently in use, for example. The arrays in common use are standardized to a fixed plate size (85.48 mm×127.67 mm) adopted by the Society of Biomolecular Screening (SBS). The spacing between individual wells on a plate has thus become progressively reduced as the number of wells has increased. As a consequence, it has not yet become practical to manipulate plastic pipette tips with robotic heads.

Disposable pipette tips are typically provided in bulk. They are manually positioned in racks in a pattern which corresponds to a selected well plate pattern. A robotic head can then be brought into registration with all or some of these “racked” tips. Conventionally, the head includes a plurality of pins, structured and arranged to register with the centers of individual pipette tips. The individual pins form seals with respective tips, effective to communicate low pressure to the interiors of the tips. The robotic head then transports the selected tips to a sample source. Samples are drawn into each tip. The robotic head then transports the tips into registration with corresponding wells of a well plate. The samples are discharged into the wells, and the tips are ejected from the robotic head. (In some instances, the tips may be washed and reused prior to ejection.) The process is then repeated through a rapid sequence of passes or cycles.

Some alternatives to the manual racking procedure have been adopted. For example, some laboratories receive preracked assemblies, which can be dispensed from a magazine directly into a rack container. Nevertheless, it remains conventional practice for robotic heads to select individual tips from a racked array. Robotic heads are conventionally provided with either 8, 96 or 384 channels, and can thus manipulate a corresponding number of pipette tips in each “pass” or cycle. Robotic heads with 1536 channels are also available, but are not currently used in connection with disposable plastic pipette tips.

U.S. Pat. No. 4,048,370 (Suovaniemi) discloses a device capable of clasping a plurality of individual pipette tips to the distal end of a pipette body. The device is incompatible with the standardized well plates and robotic heads of interest to this invention. The tip array presented by the Suovaniemi device does not accommodate to a 2:3 rectangular matrix. The disclosed device itself is incapable of interfacing with microplates, being adapted for use with much larger sample wells, generally larger than 300 milliliters.

### BRIEF SUMMARY OF THE INVENTION

This invention provides a tip plate, which organizes pipette tips in an array which substantially matches (is approximately congruent with) the pattern of the array of wells in a standard well plate. While the invention has primary application at present to the ubiquitous 96 channel and 384 channel robotic heads, it can be applied to any other known or anticipated robotic head configuration, such as the 1536 channel robotic head. A notable benefit of the invention is that it can be configured in harmony with the fit, form and function of existing conventional liquid handling robot/pipette systems. It can also be applied to multichannel hand held pipettors, which typically include either 8 or 16 channels. The tip plates of this invention are particularly beneficial from a manufacturing standpoint; specifically, by reducing the labor and automation costs involved with racking tips.

The tip plate of this invention comprises an array (a tip plate array) of individual pipette tips organized in a selected pattern and interconnected by a web structure. The tip plate array pattern is configured as n files of 8m ranks of equally spaced pipette tips, such that the tip plate array of tips can be brought into registration with a selected portion of the array of wells (a well plate array) in a standard well plate. The wells of a standard well plate are organized in an array constituting a 2:3 rectangular matrix. The tip plate array may correspond to an entire well plate array, but will more often correspond to a fractional portion—the reciprocal of an integer—of that array. The “footprint” of the web structure will register with a corresponding fractional portion of the access surface of a well plate.

The web structure may take any convenient form, provided it functions to hold the open tops of the tips in their relative positions while yielding slightly in response to localized bending forces resulting from the displacement of the distal ends of individual pipette tips. The distal ends of individual tips are thus permitted to “float,” whereby to facilitate registration of individual pins of a robotic head in sealing relationship with individual tips. This registration also serves to orient the distal ends of respective tips properly for registration with respective corresponding wells of a well plate. The selected tip pattern may be presented as a strip containing a plurality of tips corresponding to a single file (or partial file) of a well plate array. Alternatively, it may constitute a web defined by approximately planer surfaces penetrated by a plurality of tips arranged in ranks and files corresponding to all or a fractional portion of a well plate array.

One practical embodiment comprises a web structure holding two files of 16 ranks each. In any case, one or more of the tip plates may by positioned in a tip rack container to present the open tops of individual tips in a pattern substantially equivalent to the pattern presented by the open tops of manually racked bulk tips. Otherwise stated, use of the tip plates of this invention does not change significantly the tip array “seen” by a robotic head. In the case of the two file, 16 rank embodiment, 12 such tip plates may be manually racked in place of manually racking 384 individual tips.

Various web structures are operable to provide the floating capability of individual pipette tips regarded as desirable from the standpoint of this invention. The material from which the web is fashioned may be selected to provide some flexure, for example. It is within contemplation to manufacture a tip plate in a sequence of steps selected to permit the pipette tip elements to be formed from a first material, usually of polymeric composition, and the web structure to be formed from a different material. One practical manufacturing approach is to first form a web structure, and to then mold the pipette tips within that structure. Alternatively, the plate may be formed by a single manufacturing operation. In that case, flexure, or floating, capability can be provided by strategically positioning regions of reduced cross section at selected locations across the web structure. The web structure may be discontinuous, or it may be characterized by reduced thickness in regions in which greater flexibility is desired. By way of example, a web approximately 0.005 inch thick may interconnect pipette tips having a nominal thickness of about 0.030 inch. The web may be contained within a relatively inflexible skirt structure. Portions of the web, particularly immediately adjacent the open entries of the tips, may have a minimum thickness, with the remainder of the web being somewhat stiffer. It is sometimes desired for the entry ends of the tips to be either raised or indented slightly from the upper surface of the web member. That is, the open tops of the tips may advantageously terminate at a plane offset from the upper surface of the web member.

In summary, the invention may be regarded as a pipette tip plate, comprising a plurality of pipette tips arranged in approximately parallel relation in an array of ranks and files corresponding in pattern to a selected portion of a well plate. The tips may be interconnected by a web member constructed and arranged to permit limited reorientation movement of individual tips of the array. The tip plate is ideally constructed and arranged to interface with pins carried by a robotic head, such that individual pins of the robotic head are inevitably brought into registration with the interiors of corresponding pipette tips, whereby the limited reorientation movement permitted by the web facilitates establishing a fluid tight seal between those individual pins and the interiors of the respective thus-registered tips.

### BRIEF DESCRIPTION OF THE SEVERAL VIEWS OF THE DRAWINGS

In the drawings, which illustrate what is currently regarded as the best mode for carrying out the invention:

FIG. 1 is a pictorial illustration of a prior art assembly;

FIG. 2 is a pictorial illustration of a typical embodiment of the invention;

FIG. 3 is a pictorial illustration of a more elaborate alternative embodiment of the invention; and

FIG. 4 is a pictorial illustration of an embodiment similar to that illustrated by FIG. 3, but with an alternative skirt structure.

### DETAILED DESCRIPTION OF THE INVENTION

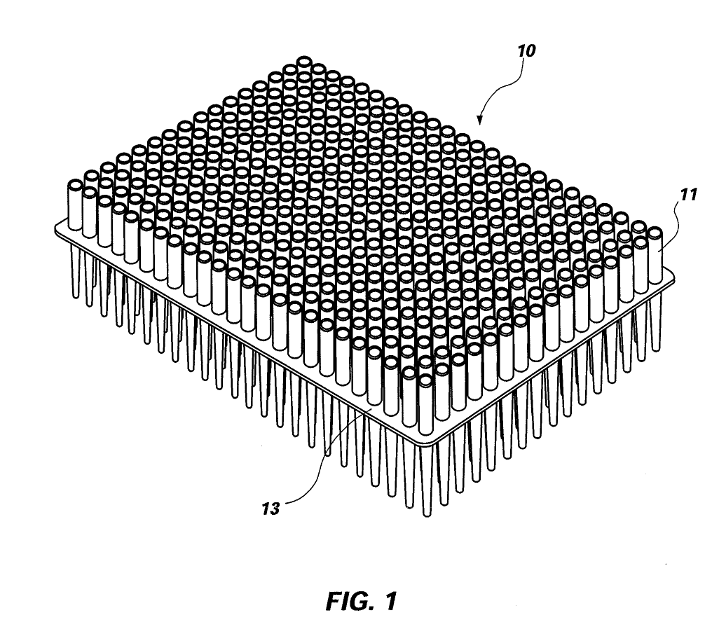

The drawings illustrate several alternative embodiments of the invention, each of which offers a “floating tip” characteristic. For comparison, FIG. 1 illustrates a prior art assembly, generally 10, including an array of 384 pipette tips 11, manually racked in a rack plate 13. The plate 13 is conventionally stored within a container (not shown), which may similarly receive assemblies of this invention.

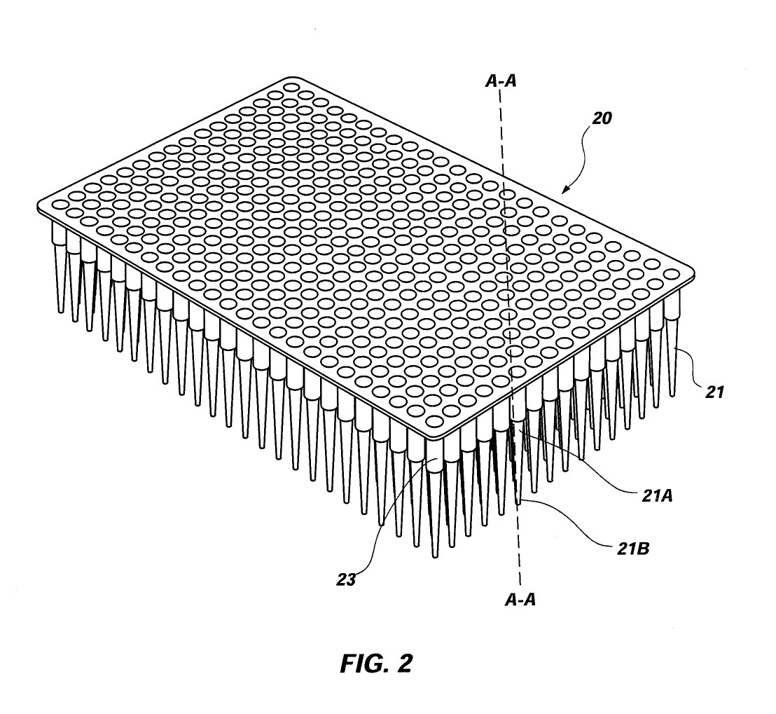

The embodiment, generally 20, of the invention, illustrated by FIG. 2, connects 384 individual pipette tips 21 within a web structure 23. It is thus the functional equivalent of the prior art assembly of FIG. 1, from the standpoint of the well array “seen” by a robotic head. It differs, mechanically, however, in that the web structure 23 obviates the need to hand rack the individual tips 21. Significantly, the web structure 23, while holding the proximal ends 21A of the tips 21 in fixed relative spatial relationship (comparable to a conventional racked array), is sufficiently flexible to permit the distal ends 21B of the tips 21 to move in any direction transverse the tip axis A-A required to accommodate sealing of the tip interior to a pin of a robotic head (not shown).

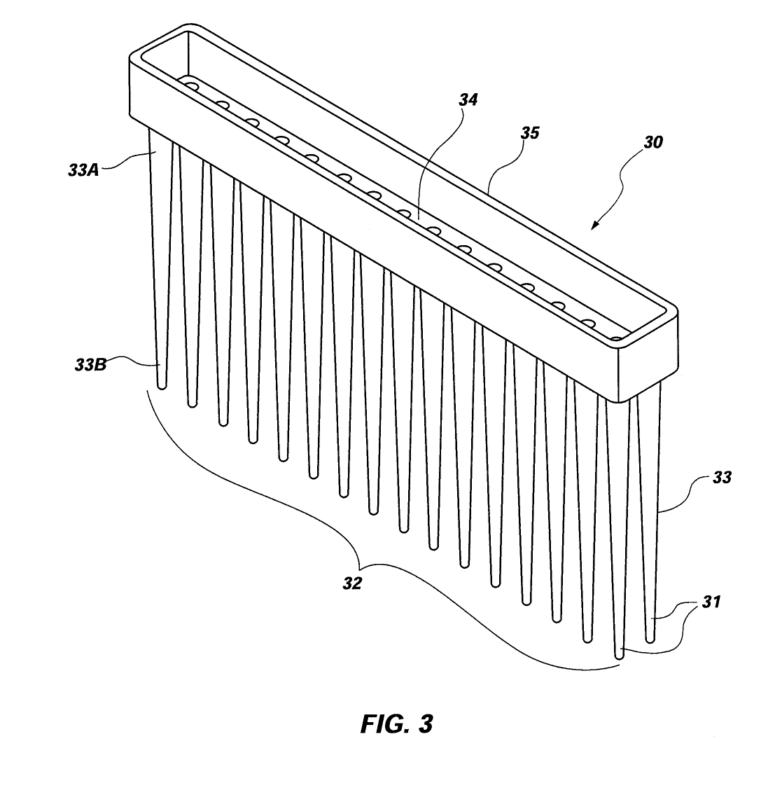

FIG. 3 illustrates an embodiment of the invention configured as a unit, generally 30, in which an array of two files 31 of sixteen ranks 32 of pipette tips 33 is connected by a web structure 34 contained within a skirt structure 35. Several such units may be combined to create patterned arrays of larger scale. For example, twelve such units may be juxtaposed, either by manual racking techniques or otherwise, to create an array of 16 files of 24 ranks (384 tips). The skirt 35 is preferably sufficiently stiff to resist deformation in use, thereby securing the proximal ends 33A of the tips 33 in fixed relative spatial position. The web structure 34 may then be constructed to exhibit the degree of flexibility required to permit adequate “floating” of the distal ends 33B.

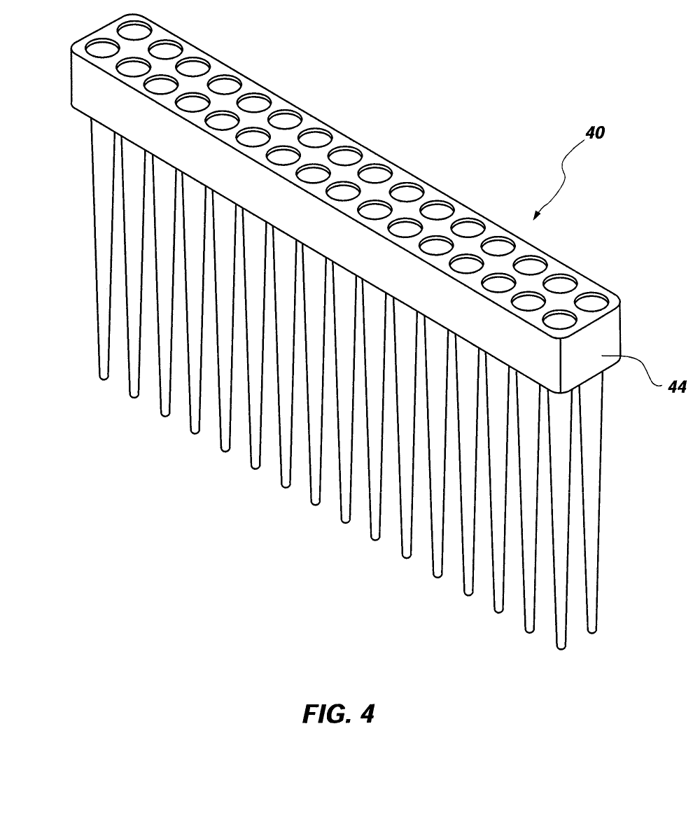

FIG. 4 illustrates an alternative embodiment, generally 40, similar to that illustrated by FIG. 3, but with an alternative skirt structure 44. In each instance, the skirt structures 35, 44 are relatively inflexible, and the tip ends 33 (FIG. 3) are permitted to float by flexure of the relatively pliable web structure 34 (FIG. 3).

what is claimed is:

1. A pipette tip plate comprising:
a plurality of pipette tips arranged in approximately parallel relation in a tip plate array of ranks and files intersecting in a pattern congruent with a selected fractional portion of a 2:3 rectangular matrix corresponding to a standard well plate array,
said tips being interconnected by a web member constructed and arranged to permit limited reorientation movement of the distal ends of individual said tips,
wherein the fractional relationship of the footprint of said tip plate to the access surface of said well plate is approximately a reciprocal integer.

2. The pipette tip plate of claim 1 constructed and arranged to interface with pins carried by a robotic head, such that individual said pins may be brought into registration with the interiors of corresponding said pipette tips, whereby said limited reorientation movement facilitates establishing a fluid tight seal between said pins and said interiors.

3. The pipette tip plate of claim 2, wherein said web member is discontinuous.

4. The pipette tip plate of claim 3 wherein said web member is characterized by reduced thickness in regions in which greater flexibility is desired

5. A pipette tip plate, comprising:
a plurality of pipette tips, each having an open top, arranged in approximately parallel relation in a tip plate array of ranks and files corresponding in pattern to a selected portion of a well plate comprising microwells arranged in a 2:3 rectangular matrix constituting a well plate array;
said tips being interconnected by a web member constructed and arranged to permit limited reorientation movement of individual said tips, while holding said open tops in their relative positions.

6. The pipette tip plate of claim 5, wherein said web member is structured to permit individual tips to “float,” whereby to facilitate registration of individual pins of a robotic head in sealing relationship with individual pins of a robotic head.

7. A pipette tip plate, comprising:
a plurality of pipette tips arranged in at least one file corresponding in pattern to a selected portion of a well plate comprising microwells arranged in a 2:3 rectangular matrix;
said tips being interconnected by a web member constructed and arranged to permit limited reorientation movement of individual said tips; and
the tops of said tips opening through an approximately planer access surface of said web member.

8. The pipette tip plate of claim 7, wherein said tips each have an open top proximate said web member and said web member is of reduced thickness in the proximity of said open tops.

9. The pipette tip plate of claim 7, including two files of 16 tips each.

10. The pipette tip plate of claim 7, wherein said web member is discontinuous.

11. The pipette tip plate of claim 7, wherein said web member is contained within a relatively inflexible skirt structure.

12. The pipette tip plate of claim 11, wherein the open tops of said tips terminate at a plane offset from the upper surface of said web member.

13. The pipette tip plate of claim 11, including two files of 16 tips each.

14. The pipette tip plate of claim 11, wherein said web member is discontinuous.

15. The pipette tip plate of claim 11, wherein said web member is contained within a relatively inflexible skirt structure.
